(19) United States
(12) Patent Application Publication
(10) Pub. No.: US 2009/0202697 A1
(43) Pub. Date: Aug. 13, 2009

(54) Sugar Substitute Compositions and Use Thereof In Foods and Beverages

(75) Inventors: Wendy Erickson, Waconia, MN (US); Timothy A. Christensen, Maple Grove, MN (US)

Correspondence Address: CARGILL, INCORPORATED, P.O. Box 5624, MINNEAPOLIS, MN, 55440-5624, US

(73) Assignee: CARGILL, INCORPORATED, WAYZATA, MN (US)

(21) Appl. No.: 11/922,544

(22) PCT Filed: Feb. 17, 2006
(86) PCT No.: PCT/US2006/005661

§ 371 Date: Dec. 19, 2007

Related U.S. Application Data
(60) Provisional application No. 60/694,303, filed on Jun. 27, 2005.

(51) Int. Cl. A23L 1/236

(52) U.S. Cl. 426/548

(57) ABSTRACT

The disclosure relates to compositions comprising erythritol, sorbitol, an ingredient selected from the group consisting of isomalt, maltitol, and a mixture of isomalt and maltitol, and an ingredient selected from the group consisting of polydextrose, a resistant maltodextrin or a mixture of polydextrose and a resistant maltodextrin. Optionally, high intensity sweeteners may be incorporated into the compositions. The compositions are useful in producing sweetened foods and beverages. The compositions may be used as a substitute for sugar in any application.

### RELATED APPLICATION

The present application claims priority to U.S. Provisional Patent Application Serial No. 60/694,303, filed Jun. 27, 2005, which is hereby incorporated by reference in its entirety.

### FIELD OF THE DISCLOSURE

The present disclosure is directed to sweetener compositions that are particularly useful as a replacement for sugar, more particularly as a replacement for sugar in the production of foods and beverages.

### BACKGROUND OF THE DISCLOSURE

It is well known to utilize sugar in the preparation of various products, such as baked goods. However, in view of the increasing obesity problem, and the rising rate of diabetes, there is a demand for sugar free sweetening compositions that could replace sugar or currently used polyols, such as maltitol, in preparing baked goods or other products. Accordingly, it would be desirable to provide a sugar free sweetener composition, that would be particularly suitable for use in the preparation of foods and beverages.

### SUMMARY OF THE DISCLOSURE

The present disclosure is directed in one embodiment, to compositions comprising erythritol, sorbitol, an ingredient selected from the group consisting of isomalt, maltitol or a mixture thereof, and an ingredient selected from polydextrose, a resistant maltodextrin, or a mixture of polydextrose and a resistant maltodextrin, in specific amounts. The disclosure is also directed to compositions, in another embodiment as described herein, that further comprise at least one or more high intensity sweeteners, such as sucralose, neotame, acesulfame potassium, or the like. The disclosure is further directed in another embodiment, to foods, such as baked goods, and beverages prepared using the compositions described herein, with or without the presence of a high intensity sweetener.

### DETAILED DESCRIPTION OF THE DISCLOSURE

The present disclosure is directed in one embodiment to compositions comprising erythritol, sorbitol, an ingredient selected from the group consisting of isomalt, maltitol or a mixture of isomalt and maltitol, and an ingredient selected from polydextrose, a resistant maltodextrin, or a mixture of polydextrose and a resistant maltodextrin, in specific amounts. The erythritol, sorbitol, isomalt, maltitol, polydextrose and maltodextrin are used, in one embodiment, in crystalline form. The disclosure is also directed to the compositions, as described herein, in another embodiment, that further comprise at least one or more high intensity sweeteners, such as sucralose, neotame, acesulfame potassium, or the like. The disclosure is further directed to in another embodiment, foods such as baked goods, and beverages prepared using the compositions described herein, with or without the presence of a high intensity sweetener.

The sweetener compositions herein in another embodiment, comprise an amount of about 5 to about 40% by weight of erythritol, based on the composition, about 20 to about 60% by weight of sorbitol, based on the composition, greater than zero (0) to about 50% by weight of an ingredient selected from the group consisting of isomalt, maltitol or a mixture thereof, based on the composition, and about 5 to about 40% by weight of polydextrose, a resistant maltodextrin, or a mixture of polydextrose and a resistant maltodextrin, based on the composition. In another embodiment, the composition comprises from about 12 to about 30% by weight of erythritol, about 35 to about 54% by weight of sorbitol, greater than zero (0) to about 35%, preferably about 2 to about 35%, of an ingredient selected from the group consisting of isomalt, maltitol or a mixture thereof, and about 10 to about 24% by weight of polydextrose. In a further embodiment, the sweetener composition comprises about 20% by weight erythritol, about 45% by weight sorbitol, about 20% by weight of an ingredient selected from the group consisting of isomalt, maltitol, or a mixture, and about 15% by weight polydextrose, a resistant maltodextrin, or a mixture of polydextrose and a resistant maltodextrin. Erythritol, sorbitol, isomalt, maltitol, polydextrose and resistant maltodextrins, are readily available materials.

Any resistant maltodextrin may be used herein as a suitable ingredient of the composition. A resistant maltodextrin is defined as a short chain polymer of glucose that is resistant to digestion in the human digestion system. Exemplary of a suitable resistant maltodextrin is FIBERSOL-2 digestion resistant maltodextrin produced by Archer Daniels Midland Company of Decatur, Ill. Any maltitol may be used herein.

The compositions described herein in another embodiment, may optionally further comprise at least one or more high intensity sweeteners. High intensity sweeteners are well known products and include, but are not limited to, sucralose (a chlorinated sucrose derivative), acesulfame potassium, neotame (also referred to as N-[N-(3,3-dimethylbutyl)-L-aspartyl]-L-phenylaniline 1-methyl ester), aspartame, saccharin, alitame, cyclamate, monatin, glycyrrhizin, thaumatin, stevia or compounds found in stevia including rebaudiosides and steviosides, brazzein, neohesperidin dihydrochalcone (NHDC), 3.4-dihydroxybenzylamine (DHBA), lo han guo, or any approved sweeteners potentiator and the like. Mixtures of high intensity sweeteners may be used in the sweetener compositions. When utilized in the sweetener compositions, the high intensity sweeteners are incorporated in one embodiment, in an amount ranging from greater than zero (0) to about 0.1% by weight, based on the composition. In another embodiment, the high intensity sweetener is incorporated in an amount of about 0.01 to about 0.08% by weight, based on the composition.

The sweetener compositions described herein in one embodiment, may be utilized for any applications where a sugar free sweetener is desired. The sweetener composition may be used in any food or beverage where the sweetener compositions would be useful. Typical applications of the sweetener compositions include, but are not limited to, all baked goods such as breads, cookies, cakes, brownies, and the like; beverages such as coffee and the like; confections such as chocolates, candies, and the like; dairy products such as cheesecake, ice cream, smoothies, yogurt, and the like; cereal bars, health bars, protein bars, and the like.

The sweetener compositions herein, with or without high intensity sweeteners, may be produced in any known manner. Typically, the compositions are produced by mixing or dry blending the components of the sweetener compositions.

The performance of the sweetener compositions herein is evaluated by utilization in the production of a cake as shown hereinafter. As a control against which to evaluate the sweetener compositions, there are produced the same cakes utilizing sugar or maltitol.

The sweetener compositions may be incorporated into the application in any amount. In another embodiment, the sweetener compositions are incorporated into the application, particularly baked goods such as cake, in an amount of about 15 to about 60% by weight of the composition. However, any amount that provides a desired effect may be used.

The following examples are presented to illustrate the present disclosure and to assist one of ordinary skill in making and using the same. The examples are not intended in any way to otherwise limit the scope of the disclosure.

### EXAMPLES

### Test Procedures

SPECIFIC GRAVITY is a measurement of air incorporated into a cake batter during mixing. The specific gravity is determined by dividing the weight of a volume of cake batter by the weight of the same volume of water. The procedure is achieved as follows:

1—Weight the cup.

2—Fill the cup with water.

3—Weigh the cup and water.

4—Subtract the cup weight.

5—Fill the cup with batter.

6—Weigh the cup and batter.

7—Subtract the cup weight.

8—Divide the batter weight by the water weight to determine specific gravity.

Specific Gravity Formula

| | |
|---|---|
| Constants | E = weight of empty cup |
| | W = weight of cup full of water |
| Variable | B = weight of cup full of batter |
| Specific gravity = | (B − E) ÷ (W − E) |

BOSTWICK VISCOSITY is a measurement of the viscosity of a batter. The Bostwick Viscosity is measured using a BOSTWICK CONSISTOMETER, available from CSC Scientific Company, Incorporated. The BOSTWICK CONSISTOMETER apparatus measures the distance, in centimeters (cm), that a batter flows in a trough over a period of 30 seconds. The test procedure is described in the instructions accompanying the apparatus.

BAKED CAKE VOLUME—This volume of a cake was determined using the Rapeseed Displacement Method. The apparatus utilized in the determination was a VOLUMETER, available from National Manufacturing Company, Lincoln, Nebr. The procedure for determining the volume of a cake accompanies the VOLUMETER apparatus. The volume is determined in cubic centimeters (cc).

BAKED CAKE EVALUATION OF INTERIOR CELL SCORE—This was determined in accordance with AACC (American Association of Cereal Chemists) Method 10-90.

BAKED CAKE TOTAL SCORE—This was determined in accordance with AACC Method 10-90.

In evaluating the sweetener compositions, the sugar, or the maltitol, as reported herein, the following yellow cake formula and test procedure were used:

Apparatus
1. 20 quart Hobart Mixer with paddle (Premix base preparation).
2. Sifter.
3. Baking Pans. Use layer pans constructed of aluminum 20.3 cm (8 inches) diameter and 3.8 cm (1⅓ inches) deep, with liners.
4. Baking oven is a rotating convection oven, fired by gas, and capable of maintaining temperature range of +5° F. Oven baking surface should be level.
5. 5 quart Hobart mixer with paddle (cake batter preparation).
6. Weigh scale, top loading (0.01 g).
7. Thermometer, ° F.

Procedure:

Preparation of dry mix base excludes some of the cake shortening, sweetener, and water.

Premix Base Formula:

| | Amounts | |
|---|---|---|
| | | % (total cake |
| Ingredient | (g) | batter formula) |
| Hi-Ratio Cake Flour | 295.2 | 24.6 |
| Egg Yolk Solids | 28.8 | 2.4 |
| Nonfat Dry Milk, hi heat | 22.8 | 1.9 |
| Emulsified Cake Shortening | 12.0 | 1.0 |
| Egg White Solids | 11.4 | 0.95 |
| Salt | 7.8 | 0.65 |
| Sodium Aluminum Phosphate | 6.96 | 0.58 |
| Baking Soda | 6.96 | 0.58 |
| Emulsifier (propylene glycol monoester, | 6.24 | 0.52 |
| mono & diglycerides, lecithin and citric acid) | | |
| Vanilla, powdered | 4.56 | 0.38 |
| Modified Food Starch (instant) | 3.24 | 0.27 |
| Xanthan Gum | 0.36 | 0.03 |

Premix Mixing/Preparation Directions:

Scale shortening and emulsifier into mixing bowl. Mix together for 2 minutes at medium speed (#2). Add dry ingredients and mix together for 5 minutes at low speed (#1). Push mix through sifter to finish. Mix sifted premix 3 minutes at low-speed (#1).

Cake Formula:

Amounts

| | | % (total cake |
|---|---|---|
| Ingredient | (g) | batter formula) |
| Emulsified Cake Shortening | 58.8 | 4.9 |
| Sugar or Sweetener Composition | 351.6 | 29.3 |
| Premix Base (from above formula) | 406.32 | 33.86 |
| Water 1 (First Stage) | 209.04 | 17.42 |
| Water 2 (Second Stage) | 174.24 | 14.5 |
| TOTAL | 1200 | 100 |

Cake Preparation:
1. Put shortening, premix base, and sugar or sweetener composition into Hobart 5 qt. Bowl.
2. Start mixing on 1^{st} speed for 1 minute, adding water 1 within this first minute.
3. Shift mixing speed to 2^{nd} and mix for 4 minutes.
4. Add water 2 and mix for 30 seconds.
5. Scrape down bowl and paddle.
6. Mix 4 minutes on low speed (#1).
7. Spray interior sides of the baking pans and place a liner into the bottom of the pan.
8. Place lined pan on scale and zero.
9. Take batter temperature, determine batter's specific gravity, and determine Bostwick viscosity. Scale 370 g of batter into the pans. (3 cakes each batch).
10. Bake in convection oven for 28 minutes at 330° F.
11. Evaluate cake volumes with rapeseed displacement method approximately 2 hours after baking.
12. Conduct cake evaluation (AACC method 10-90) the next day.

### Example 1

In this example, there were compared cakes produced with two (2) sweetener compositions of the present disclosure, and cakes produced using sugar or maltitol. The procedure used for producing all of the four (4) cakes is described above, where it is shown that 29.3% by weight of the cake is the sugar, maltitol or sweetener compositions.

In the evaluations reported in the following Table 1, the samples identified as Samples Numbers 1-4 are as follows:

(a) Sample No. 1 was cake produced using sugar;
(b) Sample No. 2 was cake produced using maltitol;
(c) Sample No. 3 was cake produced using a sweetener composition comprising 45% by weight sorbitol, 20% by weight erythritol, 20% by weight isomalt, and 15% by weight polydextrose; and
(d) Sample No. 4 was cake produced using a sweetener composition comprising 45% by weight sorbitol, 20% by weight erythritol, 19.95% by weight isomalt, 15% by weight polydextrose; and 0.05% by weight of a blend of acesulfame potassium and neotame.

TABLE 1

| | BOSTWICK | Specific | Cake | Cake | |
|---|---|---|---|---|---|
| Sample | Viscosity, | Gravity, | Volume, | Interior | Total Cake |
| No. | cm/30 sec. | g/cc | cc | Cell Score | Score |
| 1 | 8.75 | 0.92 | 1080 | 23.0 | 81 |
| 2 | 8.10 | 0.89 | 1060 | 24.0 | 88 |
| 3 | 7.90 | 0.82 | 1085 | 22.0 | 81 |
| 4 | 7.90 | 0.82 | 1080 | 20.0 | 82 |

From the data in Table 1, it may be noted that the viscosity and specific gravity properties of the cakes produced with sweetener compositions of samples numbers 3 and 4, are generally similar to the properties of cakes produced using sugar and maltitol. Furthermore, the performance of the sweetener compositions of samples numbers 3 and 4, in producing a cake, appear to be generally similar to the performance characteristics of using sugar or maltitol in producing cakes. These properties include cake volume, cake interior cell score, and total cake score.

It may also be noted that the performance of cakes produced using sweetener compositions samples numbers 3 and 4 are substantially similar regardless of the usage of a high intensity sweetener blend in sample number 4, whereas no high intensity sweetener was utilized in sample number 3.

### Example 2

In this example, there were compared three cake samples produced as described above. Sample No. 1 was produced using sugar, and Sample No. 2 was produced using maltitol. Sample No. 3 was produced using a sweetener composition comprising 45% by weight sorbitol, 20% by weight erythritol, 20% by weight isomalt, and 15% by weight polydextrose. The data from the evaluation is reported in Table 2.

TABLE 2

| | BOSTWICK | Specific | Cake |
|---|---|---|---|
| Sample | Viscosity, | Gravity, | Volume, |
| No. | cm/30 sec. | g/cc | cc |
| 1 | 10.25 | 0.98 | 1115 |
| 2 | 8.75 | 0.93 | 1100 |
| 3 | 9.50 | 0.90 | 1120 |

The data in Table 2 show that the cake produced using the sweetener composition of sample number 3 has physical properties of viscosity and specific gravity that are generally similar to cakes produced using sugar or maltitol. Moreover, the cakes produced with the sugar, or maltitol, or sweetener composition of Sample Number 3, exhibit similar cake volume values.

### Example 3

In this example, there were compared three cake samples produced as described above. Sample No. 1 was a cake produced using maltitol. Sample No. 2 was a cake produced using a sweetener composition comprising 45% by weight sorbitol, 20% weight erythritol, 20% by weight isomalt, and 15% by weight polydextrose. Sample No. 3 was a cake produced using a sweetener composition comprising 45% by weight sorbitol, 20% by weight erythritol, 19.95% by weight isomalt, 15% by weight polydextrose, and 0.05% by weight sucralose high intensity sweetener. The data resulting from the evaluation is reported in Table 3.

TABLE 3

| | BOSTWICK | Specific | Cake |
|---|---|---|---|
| Sample | Viscosity, | Gravity, | Volume, |
| No. | cm/30 sec. | g/cc | cc |
| 1 | 8.75 | 0.92 | 1025 |
| 2 | 9.75 | 0.91 | 1080 |
| 3 | 9.75 | 0.91 | 1100 |

From a review of the data in Table 3, it is apparent that the cakes produced using sweetener compositions of the present disclosure, identified as Samples Numbers 2 and 3, have physical properties similar to a maltitol containing cake, and that the cake volumes are similar. Further, as the data for Samples Numbers 2 and 3 show, the presence of sucralose (a high intensity sweetener) does not impact or alter cake performance, as compared with a cake produced using the same sweetener composition that does not contain a high intensity sweetener, such as sucralose.

### Example 4

In this example there was produced a cake utilizing a sweetener composition comprising 25% by weight of each of sorbitol, erythritol, isomalt, and polydextrose. It was determined that the BOSTWICK viscosity was 10.50 cm/30 sec; the specific gravity was 0.90 g/cc; the cake volume was 1075 cc; the cake interior cell score was 17, and the total cake score was 77. As the data indicate, the cake of this example was a suitable product.

The disclosure has been described with reference to various specific and illustrative embodiments and techniques. However, one skilled in the art will recognize that many variations and modifications may be made while remaining within the spirit and scope of the disclosure.

What is claimed is:

1. A composition comprising about 5 to about 40% by weight erythritol, based on the composition, about 20 to about 60% by weight sorbitol, based on the composition, greater than zero to about 50% by weight of an ingredient selected from the group consisting of isomalt, maltitol, and a mixture of isomalt and maltitol, based on the composition, and about 5 to about 40% by weight of an ingredient selected from the group consisting of polydextrose, a resistant maltodextrin, and a mixture of polydextrose and a resistant maltodextrin, based on the composition.

2. The composition according to claim 1 wherein the erythritol content is about 12 to about 30% by weight, the sorbitol content is about 35 to about 54% by weight, the content of the ingredient selected from the group consisting of isomalt, maltitol, and a mixture of isomalt and maltitol, is greater than zero to about 35%, by weight, and the content of the ingredient selected from the group consisting of polydextrose, resistant maltodextrin, and mixture thereof, is about 10 to about 24% by weight.

3. The composition according to claim 2 wherein the erythritol content is about 20% by weight, the sorbitol content is about 45% by weight, the content of the ingredient selected from the group consisting of isomalt, maltitol, and mixture of isomalt and maltitol, is about 20% by weight, and the content of the ingredient selected from the group consisting of polydextrose, resistant maltodextrin, and mixture thereof, is about 15% by weight.

4. The composition according to claim 1 further comprising at least one high intensity sweetener.

5. The composition according to claim 3 further comprising at least one high intensity sweetener.

6. The composition according to claim 4 wherein the high intensity sweetener is present in an amount of greater than zero to about 0.1% by weight, based on the composition.

7. The composition according to claim 6 wherein the high intensity sweetener is present in an amount of about 0.01 to about 0.08% by weight.

8. The composition according to claim 4 wherein the high intensity sweetener is selected from the group consisting of sucralose, neotame, acesulfame potassium, aspartame, saccharin, alitame, cyclamate, monatin, glycyrrhizin, a sweetness potentiator, and mixtures thereof.

9. The composition according to claim 6 wherein the high intensity sweetener is selected from the group consisting of sucralose, neotame, acesulfame potassium, aspartame, saccharin, alitame, cyclamate, monatin, glycyrrhizin, a sweetness potentiator, and mixtures thereof.

10. The composition according to claim 9 wherein the high intensity sweetener is sucralose.

11. The composition according to claim 9 wherein the high intensity sweetener is a mixture of neotame and acesulfame potassium.

12. A food composition comprising food and the composition according to claim 1.

13. A food composition comprising food and the composition according to claim 4.

14. The food composition according to claim 12 wherein the food is selected from the group consisting of a baked good, a confection, a dairy product, a cereal bar, a health bar, and a protein bar.

15. The food composition according to claim 13 wherein the food is selected from the group consisting of a baked good, a confection, a dairy product, a cereal bar, a health bar, and a protein bar.

16. The food composition according to claim 14 wherein the food is a baked good.

17. The food composition according to claim 15 wherein the food is a baked good.

18. A beverage composition comprising a beverage and the composition according to claim 1.

19. A beverage composition comprising a beverage and the composition according to claim 4.

20. A process for sweetening a food comprising combining the food with the composition according to claim 1.

21. A process for sweetening a food comprising combining the food with the composition according to claim 4.

22. A process for sweetening a beverage comprising combining the beverage with the composition according to claim 1.

23. A process for sweetening a beverage comprising combining the beverage with the composition according to claim 4.
